(19) United States
(12) Patent Application Publication
(10) Pub. No.: US 2020/0385149 A1
(43) Pub. Date: Dec. 10, 2020

(54) FLYING OBJECT

(71) Applicant: HONDA MOTOR CO., LTD., Tokyo (JP)

(72) Inventors: Tetsuya Gomi, Wako-shi (JP); Hiroyuki Yamashita, Wako-shi (JP); Takahira Kawata, Wako-shi (JP); Koh Kamachi, Tokyo (JP)

(21) Appl. No.: 16/865,445

(22) Filed: May 4, 2020

(30) Foreign Application Priority Data
May 13, 2019 (JP) 2019-090565

(51) Int. Cl. B64G 1/58; B64G 1/62

(52) U.S. Cl. CPC B64G 1/58; B64G 1/62

(57) ABSTRACT

A flying object includes a housing formed by combining a plurality of panels having reinforced fibers and a matrix resin, and a low melting point member having a lower melting point than that of at least the reinforced fiber, wherein the housing is configured to be breakable according to a change of the low melting point member during either of fusion or sublimation.

### CROSS-REFERENCE TO RELATED APPLICATION

Priority is claimed on Japanese Patent Application No. 2019-090565, filed May 13, 2019, the content of which is incorporated herein by reference.

### BACKGROUND OF THE INVENTION

### Field of the Invention

The present invention relates to a flying object.

### Description of Related Art

Japanese Patent No. 5638271 discloses a configuration of a flying object in which an ablator is disposed from a front section to a side portion of the flying object and the ablator is formed by impregnating a resin (a matrix resin) into a fiber matrix (a reinforced fiber). The ablator generates an ablation gas through sublimation upon atmospheric re-entry. In addition, according to the technology disclosed in Japanese Patent No. 5638271 in which the ablator has at least a part of an ablator region having a density of reinforced fibers that gradually or continuously increases from the front section toward the side portion, movement of the generated ablation gas to the side portion is restricted by the ablator region, and the ablation gas is ejected forward. Accordingly, heat protection properties of the front section of the flying object can be improved.

### SUMMARY OF THE INVENTION

Incidentally, in order to reduce the influence on a surrounding region upon falling after atmospheric re-entry, it is required to decrease the collision energy of a flying object at the time of falling. As a method of decreasing the collision energy, a method of incinerating the flying object through aerodynamic heating upon atmospheric re-entry is known. For this reason, in the related art, as a material of a housing of the flying object, a metal material such as aluminum or the like having a low melting point and a low boiling point is used.

While aluminum is known as a relatively light metal, in recent years, there has been demand for further reduction in weight in order to reduce the launching costs.

An aspect of the present invention provides a flying object in which both weight reduction and improvement in incineration characteristics at the time of atmospheric reentry are achieved.

(1) A flying object according to an aspect of the present invention includes a housing formed by combining a plurality of panels including reinforced fibers and a matrix resin; and a low melting point member having a lower melting point than that of at least the reinforced fibers, wherein the housing is configured to be breakable according to a change of the low melting point member during either of fusion or sublimation.

(2) In addition, in the aspect of the above-mentioned (1), a cavity section may be formed in at least a part of the housing, and the low melting point member may cover at least a part of the cavity section.

(3) In addition, in the aspect of the above-mentioned (2), the housing may be formed in a polyhedron shape, and the cavity section may be provided on at least one of a side of the housing that is a boundary portion between neighboring surfaces of the housing.

(4) In addition, in the aspect of the above-mentioned (2), the housing may be formed in a polyhedron shape, and the cavity section may be provided in at least one of a surface of the housing.

(5) In addition, in the aspect of the above-mentioned (2), the housing may be formed in a polyhedron shape, and the cavity section may be provided in at least one of a corner section of the housing.

(6) In addition, in the aspect of the above-mentioned (1), the low melting point member may have a fibrous form, and may be provided integrally with the panel when the low melting point member is contained in the panel.

(7) In addition, in the aspect of the above-mentioned (1) or (6), the low melting point member may be provided integrally with the panel when the low melting point member is contained in the matrix resin.

(8) In addition, in the aspect of any one of the above-mentioned (1) to (7), the panel may have a protrusion protruding outward from the housing.

According to the aspect of the above-mentioned (1), since the housing is formed by combining a plurality of panels having reinforced fibers and a matrix resin, the weight of the housing can be reduced in comparison with the case in which the housing is formed of a metal material such as aluminum, while the strength of the housing can be improved. Meanwhile, since the flying object has the low melting point member, for example, the housing can be broken down from the low melting point member as a starting point through fusion or sublimation of the low melting point member before aerodynamic heating upon atmospheric re-entry. Accordingly, the housing formed of a material such as a reinforced fiber or the like having a melting point and a boiling point higher than those of aluminum can be reliably broken down and incineration properties upon atmospheric re-entry can be improved. In addition, for example, when an internal structure is mounted in the housing, the internal structure and the housing can be efficiently incinerated by collapsing the housing.

Accordingly, it is possible to provide a flying object in which both of reduction in weight and improvement in incineration properties upon atmospheric re-entry are accomplished.

According to the aspect of the above-mentioned (2), since the housing has the cavity section and the low melting point member covers at least a part of the cavity section, the cavity section of the housing can be exposed to the outside through fusion or sublimation of the low melting point member upon atmospheric re-entry. Accordingly, the cavity section is enlarged through sublimation of the end portion of the cavity section, the internal structure is sublimated through aerodynamic heating while a high pressure air enters the housing from the cavity section, and a force of collapsing the housing is applied from an inward side toward an outward side of the housing by the pressure caused when the internal structure is sublimated and the pressure of the entering air. Accordingly, the housing can be easily broken down.

According to the aspect of the above-mentioned (3), since the housing is formed in a polyhedron shape and the cavity section is provided on at least one side of the housing, collapse of the housing can be started from the corner portion including a side of the housing. Accordingly, the housing can be reliably broken down from the corner portion including the side of the housing as a starting point.

According to the aspect of the above-mentioned (4), since the housing is formed in a polyhedron shape and the cavity section is provided on at least one of a surface of the housing, collapse of the housing can be started from the surface portion. Accordingly, the housing can be reliably broken down from the surface portion of the housing as a starting point.

According to the aspect of the above-mentioned (5), since the housing is formed in a polyhedron shape and the cavity section is provided in at least one of a corner section of the housing, collapse of the housing is started from the corner section. Accordingly, the housing can be reliably broken down from the corner section of the housing as a starting point.

According to the aspect of the above-mentioned (6), since the low melting point member is provided integrally with the panel when the fibrous low melting point member is contained in the panel, there is no need to separately dispose the low melting point member in the housing. Accordingly, for example, since an adhesive agent, a fastening member, or the like, configured to join the low melting point member and the housing is not necessary, the housing can be simplified. In addition, since there is no need to provide the cavity section in the housing, workability upon manufacture can be improved.

Further, since the fibrous low melting point member can be disposed throughout a large region of the panel, in comparison with the case in which the low melting point member is disposed in a region of a part of the panel, the panel can be more finely broken down upon atmospheric re-entry. Accordingly, it is possible to provide a flying object in which incineration properties upon atmospheric re-entry are further improved.

According to the aspect of the above-mentioned (7), the low melting point member is provided integrally with the panel when the low melting point member is contained in the matrix resin. According to the configuration, for example, the low melting point member can be distributed and contained in the entire panel. Accordingly, the entire panel can be easily broken down through aerodynamic heating upon atmospheric re-entry. Accordingly, it is possible to provide the flying object in which incineration properties upon atmospheric re-entry can be further improved.

According to the aspect of the above-mentioned (8), since the panel has the protrusions, points at which air stagnates is easily generated in the vicinity of the protrusions in an outer surface of the housing. Since the air reaches a higher temperature at such stagnation points, the housing can be heated to a higher temperature in comparison with the case in which the panel does not have protrusions. Accordingly, the panel that constitutes the housing can be more reliably incinerated.

### BRIEF DESCRIPTION OF THE DRAWINGS

FIG. 1 is an external perspective view of a flying object according to a first embodiment.

FIG. 2 is a cross-sectional view taken along line II-II in FIG. 1.

FIG. 3 is an enlarged view of a portion III in FIG. 2.

FIG. 4 is a view illustrating an aspect of the flying object according to the first embodiment during collapse.

FIG. 5 is an external perspective view of a flying object according to a second embodiment.

FIG. 6 is a cross-sectional view taken along line VI-VI in FIG. 5.

FIG. 7 is an external perspective view of a flying object according to a third embodiment.

FIG. 8 is a cross-sectional view taken along line VIII-VIII in FIG. 7.

FIG. 9 is a cross-sectional view taken along line IX-IX in FIG. 7.

FIG. 10 is an external perspective view of a flying object according to a fourth embodiment.

FIG. 11 is a front view of a panel according to a fifth embodiment.

FIG. 12 is an enlarged view of the panel according to the fifth embodiment.

FIG. 13 is an external perspective view of a flying object according to a sixth embodiment.

FIG. 14 is a cross-sectional view of a protrusion according to the sixth embodiment.

FIG. 15 is a cross-sectional view of a protrusion according to a first variant of the sixth embodiment.

### DETAILED DESCRIPTION OF THE INVENTION

Hereinafter, embodiments of the present invention will be described with reference to the accompanying drawings.

### First Embodiment

### (Flying Object)

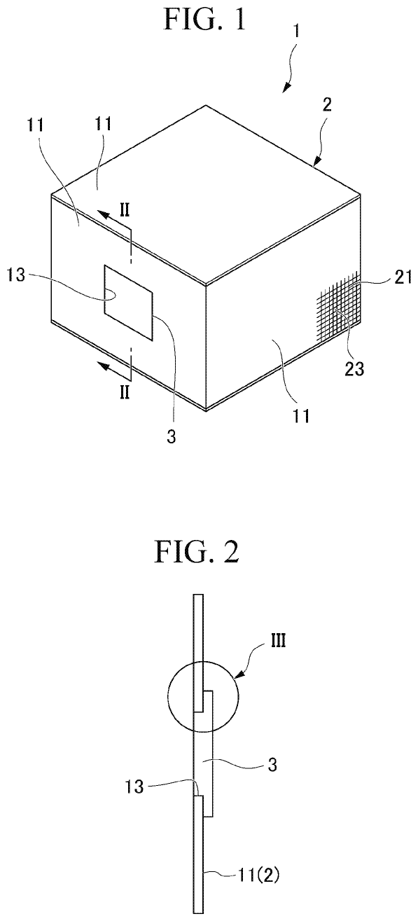

FIG. 1 is an external perspective view of a flying object 1 according to a first embodiment.

The flying object 1 is, for example, an artificial satellite or the like that re-enters the atmosphere and then sublimates after the artificial satellite has been launched into outer space and performed various experiments or the like.

The flying object 1 includes a housing 2, and a low melting point member 3.

### (Housing)

The housing 2 has a plurality of panels 11, and a cavity section 13. The housing 2 is combined with the plurality of panels 11 to form a polyhedron shape. Specifically, in the embodiment, the housing 2 is formed in a rectangular parallelepiped shape by joining the six panels 11 using fastening members such as bolts or the like, an adhesive agent, or the like (not shown). The housing 2 has a hollow shape having a space formed therein. For example, an internal structure (not shown) that is an apparatus for experiment is accommodated in the housing 2.

The panels 11 have reinforced fibers 21, and a matrix resin 23.

The reinforced fibers 21 are, for example, carbon fibers. The matrix resin 23 is, for example, a thermosetting resin.

The panels 11 are formed of so-called carbon fiber reinforced plastic (CFRP) formed by infiltration of the matrix resin 23 between a plurality of reinforced fibers 21 disposed in a predetermined direction.

The cavity section 13 is provided in at least a region of a part of the housing 2. In the embodiment, the cavity section 13 is provided in a central section of the panel 11 that constitutes one surface in a rectangular parallelepiped shape. The cavity section 13 is, for example, a hole passing through the panel 11 in a plate thickness direction. The cavity section 13 is formed in a rectangular shape when seen from a front surface of the panel 11 in which the cavity section 13 is provided.

### (Low Melting Point Member)

The low melting point member 3 is formed of a material having a lower melting point than that of at least the reinforced fiber 21. Specifically, the low melting point member 3 is formed of aluminum. Further, the low melting point member 3 may be formed of a metal material having a low melting point other than aluminum, for example, magnesium or the like. The low melting point member 3 covers at least a part of the cavity section 13 in the housing 2. In the embodiment, the low melting point member 3 covers the cavity section 13 as a whole.

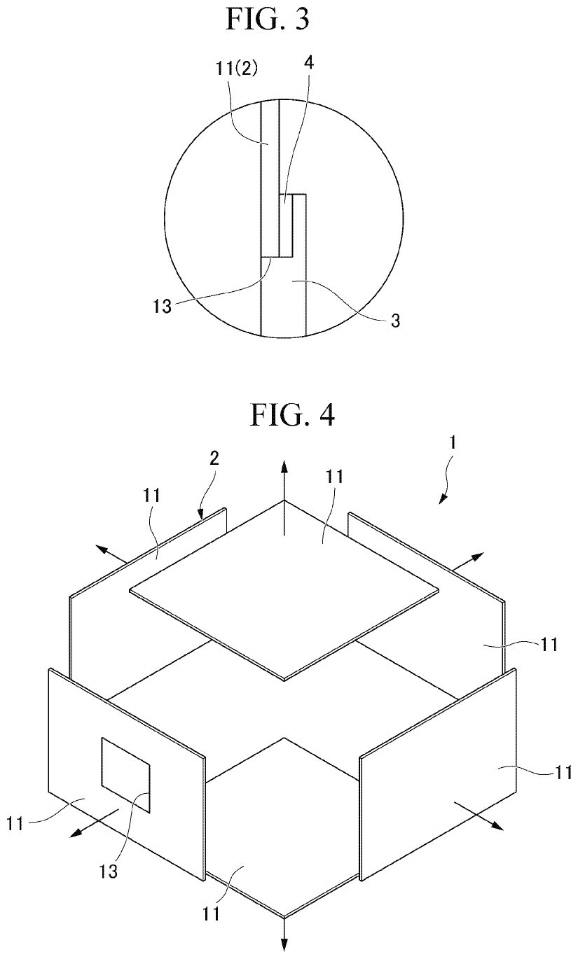

FIG. 2 is a cross-sectional view taken along line II-II of FIG. 1. FIG. 3 is an enlarged view of a portion III of FIG. 2.

As shown in FIG. 2, the low melting point member 3 is attached to the housing 2 from an inward side of the housing 2. As shown in FIG. 3, the low melting point member 3 is adhered and fixed to an inner surface of the panel 11 that constitutes the housing 2 by an adhesive agent 4. A part of the low melting point member 3 is exposed to the outside of the housing 2 via the cavity section 13.

### (Actions and Effects of Flying Object)

Next, actions and effects of the flying object 1 will be described.

The flying object 1 re-enters the atmosphere toward the ground after being launched into outer space. Upon atmospheric re-entry, aerodynamic heating occurs in the flying object 1 as air is compressed at a high pressure. According to the aerodynamic heating, first, the low melting point member 3 is melted or sublimated.

FIG. 4 is a view for describing an aspect of the flying object 1 according to the first embodiment during collapse.

After the low melting point member 3 is melted or sublimated, the cavity section 13 enlarges as an end portion of the cavity section 13 is sublimated, and a high pressure air flows into the housing 2 from the cavity section 13. The air flowed into the housing 2 sublimates the internal structure, the housing 2 is pressed from an inward side toward an outward side by the pressure caused when the internal structure is sublimated and the pressure of the flowing air flowed into the housing, and the housing 2 is broken down.

Further, the broken down housing 2 is incinerated through aerodynamic heating and burned up or finely broken down by the atmosphere. In addition, since the housing 2 is broken down, the internal structure or the like accommodated in the housing 2 is exposed to the air. Accordingly, the housing and the internal structure are efficiently incinerated.

According to the flying object 1 of the embodiment, since the housing 2 is formed by combining the plurality of panels 11 having the reinforced fibers 21 and the matrix resin 23, in comparison with the case in which the housing 2 is formed of a metal material such as aluminum or the like, while the strength of the housing 2 can be improved, the weight of the housing 2 can be reduced. Meanwhile, since the flying object 1 has the low melting point member 3, for example, the housing 2 can be broken down from the low melting point member 3 as a starting point through fusion or sublimation of the low melting point member 3 due to aerodynamic heating upon atmospheric re-entry. Accordingly, the housing 2 formed of a material such as the reinforced fiber 21 or the like having a melting point and a boiling point that are higher than those of aluminum can be reliably broken down, and incineration properties upon atmospheric re-entry can be improved. In addition, for example, when the internal structure or the like is mounted in the housing 2, the internal structure or the like and the housing 2 can be efficiently incinerated as the housing 2 is broken down.

Accordingly, it is possible to provide the flying object 1 in which both of reduction in weight and improvement in incineration properties upon atmospheric re-entry are accomplished.

Since the housing 2 has the cavity section 13 and the low melting point member 3 covers at least a part of the cavity section 13, the cavity section 13 of the housing 2 is exposed to the outside due to fusion or sublimation of the low melting point member 3 upon atmospheric re-entry. Accordingly, the cavity section 13 is enlarged through sublimation of the end portion of the cavity section 13, the internal structure is sublimated through aerodynamic heating while a high pressure air enters the housing 2 from the cavity section 13, and a force of collapsing the housing 2 is applied from the inward side toward the outward side of the housing 2 by the pressure caused when the internal structure is sublimated and the pressure of the flowing air flowed into the housing. Accordingly, the housing 2 can be easily broken down.

Since the housing 2 is formed in a rectangular parallelepiped shape (a polyhedron shape) and the cavity section 13 is provided on at least one surface of the housing 2, collapse of the housing 2 is started from the surface portion. Accordingly, the housing 2 can be reliably broken down from the surface portion of the housing 2 as a starting point.

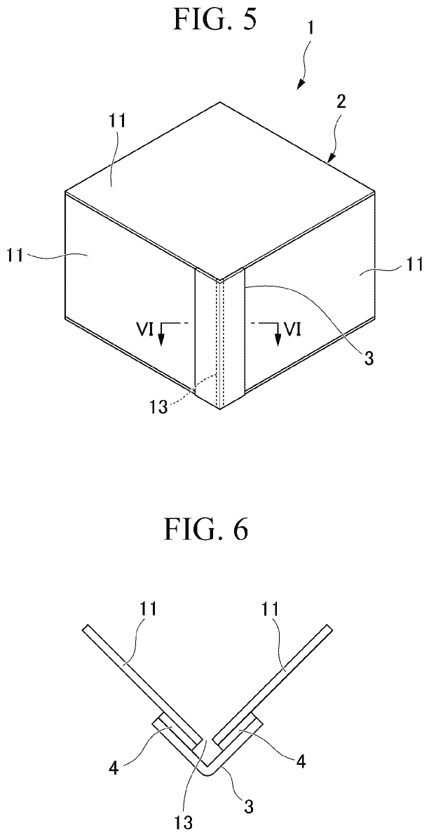

Next, a second embodiment to a sixth embodiment of the present invention will be described with reference to FIG. 5 to FIG. 15. In the following description, components the same as those of the above-mentioned first embodiment are designated by the same reference signs and appropriate description thereof will be omitted. In addition, reference signs related to the other components described in FIG. 5 to FIG. 15 will be appropriately referenced to FIG. 1 to FIG. 4.

### Second Embodiment

A second embodiment according to the present invention will be described. FIG. 5 is an external perspective view of a flying object 1 according to the second embodiment. FIG. 6 is a cross-sectional view taken along line VI-VI of FIG. 5. The embodiment is distinguished from the above-mentioned embodiment in that the low melting point member 3 is provided on a corner portion including a side of the housing 2.

As shown in FIG. 5, in the embodiment, the cavity section 13 is provided on one side that is a boundary portion between the neighboring panels 11 in the rectangular parallelepiped shape of the housing 2. The low melting point member 3 covers the cavity section 13 formed in the corner portion including the side of the housing.

As shown in FIG. 6, the low melting point member 3 is attached to the housing 2 from the outward side of the housing 2. Specifically, the low melting point member 3 is formed in a V-shaped cross section along each of the neighboring two panels 11. The low melting point member 3 is adhered and fixed to a surface of the panel 11 directed outward by the adhesive agent 4. The low melting point member 3 is exposed to the outside of the housing 2.

According to the configuration of the embodiment, since the housing 2 is formed in a rectangular parallelepiped shape (a polyhedron shape) and the cavity section 13 is provided on at least one of the side of the housing 2, collapse of the housing 2 is started from the corner portion of the housing 2 including the side. Accordingly, the housing 2 can be reliably broken down from the corner portion including the side of the housing 2 as a starting point.

### Third Embodiment

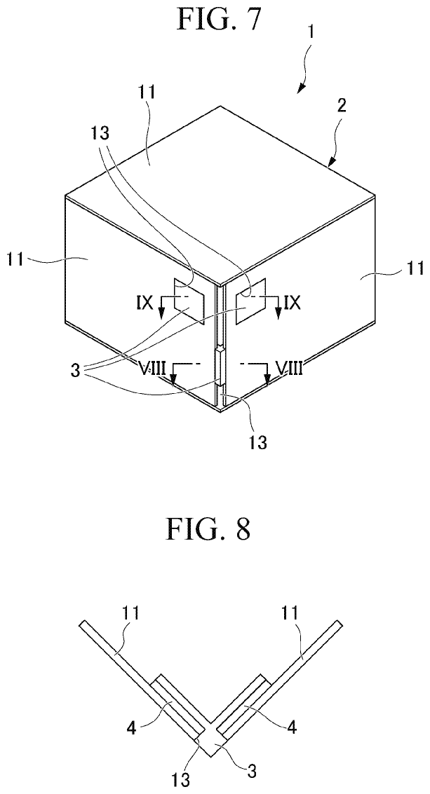

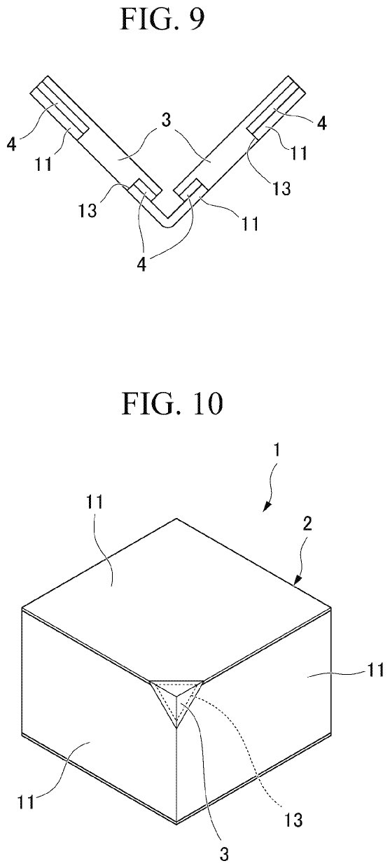

A third embodiment according to the present invention will be described. FIG. 7 is an external perspective view of a flying object 1 according to the third embodiment. FIG. 8 is a cross-sectional view taken along line VIII-VIII of FIG. 7. FIG. 9 is a cross-sectional view taken along line IX-IX of FIG. 7. The embodiment is distinguished from the above-mentioned embodiment in that the low melting point members 3 are provided on the corner portion including the side of the housing 2 and the surface portion of the housing 2, respectively.

As shown in FIG. 7, in the embodiment, the cavity sections 13 are provided respectively in one side that is a boundary portion between the neighboring panels 11 in a rectangular parallelepiped shape of the housing 2, and surfaces of the neighboring panels 11 with the side sandwiched therebetween. The low melting point member 3 covers the cavity sections 13.

As shown in FIG. 8, in the corner portion including the side of the housing 2, the low melting point member 3 is attached to the housing 2 from the inward side of the housing 2. Specifically, the low melting point member 3 is formed in a V-shaped cross section along each of the neighboring two panels 11. The low melting point member 3 is adhered and fixed to each of inner surfaces of the two panels 11 by the adhesive agent 4.

As shown in FIG. 9, in the surface portion, the low melting point members 3 are attached to the housing 2 from the inward side of the housing 2. Specifically, the low melting point members 3 are provided on the two panels 11 in which the cavity sections 13 are formed, respectively. The low melting point members 3 are adhered and fixed to the inner surfaces of the two panels 11 by the adhesive agent 4, respectively.

According to the configuration of the embodiment, collapse of the housing 2 is started from the corner portion including the side and the surface portion in which the cavity sections 13 are formed. Accordingly, the housing 2 can be reliably broken down from the corner portion including the side and the surface portion of the housing 2 as starting points.

### Fourth Embodiment

A fourth embodiment according to the present invention will be described. FIG. 10 is an external perspective view of a flying object 1 according to the fourth embodiment. The embodiment is distinguished from the above-mentioned embodiment in that the low melting point member 3 is provided on a corner section of the housing 2.

In the embodiment, the cavity section 13 is provided on the corner section in a rectangular parallelepiped shape of the housing 2. The low melting point member 3 covers the cavity section 13 formed in the corner section.

The low melting point member 3 is attached to the housing 2 from the outward side of the housing 2. Specifically, the low melting point member 3 is adhered and fixed to each of surfaces of the neighboring three panels 11 directed outward by the adhesive agent 4. The low melting point member 3 is exposed to the outside of the housing 2.

According to the configuration of the embodiment, since the housing 2 is formed in a rectangular parallelepiped shape (a polyhedron shape) and the cavity section 13 is provided in at least one corner section of the housing 2, collapse of the housing 2 is started from the corner section. Accordingly, the housing 2 can be reliably broken down from the corner section of the housing 2 as a starting point.

### Fifth Embodiment

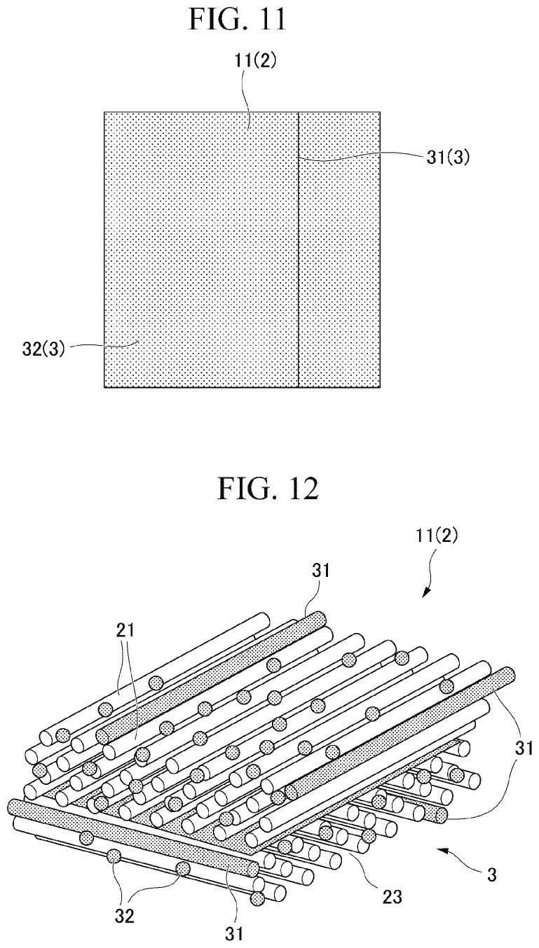

A fifth embodiment according to the present invention will be described. FIG. 11 is a front view of a panel 11 according to the fifth embodiment. FIG. 12 is an enlarged view of the panel 11 according to the fifth embodiment. The embodiment is distinguished from the above-mentioned embodiment in that the low melting point member 3 is provided integrally with the panel 11.

As shown in FIG. 11, in the embodiment, the low melting point member 3 is provided integrally with the panel 11 as the low melting point member 3 is contained in the panel 11. Specifically, the low melting point member 3 has fibrous low melting point members 31 formed in a fibrous form, and particulate low melting point members 32 formed in a particulate shape.

As shown in FIG. 12, the fibrous low melting point members 31 are disposed alongside the reinforced fibers 21. The fibrous low melting point members 31 are contained in the panel 11 by infiltrating the matrix resin 23 between the plurality of reinforced fibers 21 and the plurality of fibrous low melting point members 31.

The particulate low melting point members 32 are contained in the matrix resin 23. The particulate low melting point members 32 are, for example, additives added to the matrix resin 23.

Further, the low melting point member 3 may have only one of the fibrous low melting point members 31 and the particulate low melting point members 32.

According to the configuration of the embodiment, since the low melting point member 3 is provided integrally with the panels 11 as the fibrous low melting point member 3 (the fibrous low melting point members 31) is contained in the panel 11, there is no need to separately dispose the low melting point member 3 in the housing 2. Accordingly, for example, an adhesive agent, a fastening member, or the like, configured to join the low melting point member 3 and the housing 2 is unnecessary, and the housing 2 can be simplified. In addition, since there is no need to provide the cavity section 13 in the housing 2, workability upon manufacture can be improved.

Further, since the fibrous low melting point member 3 can be disposed throughout the wide region of the panel 11, in comparison with the case in which the low melting point member 3 is disposed in a region of a part of the panel 11, the panel 11 can be more finely broken down upon atmospheric re-entry. Accordingly, it is possible to provide the flying object 1 in which incineration properties upon atmospheric re-entry are further improved.

In addition, the low melting point members 3 (the particulate low melting point members 32) are provided integrally with the panel 11 as the low melting point member 3 (the particulate low melting point members 32) is contained in the matrix resin 23. According to the configuration, for example, the low melting point members 3 can be distributed and contained in entire of the panels 11. Accordingly, entire of the panels 11 can be easily broken down by aerodynamic heating upon atmospheric re-entry. Accordingly, it is possible to provide the flying object 1 in which incineration properties upon atmospheric re-entry are further improved.

### Sixth Embodiment

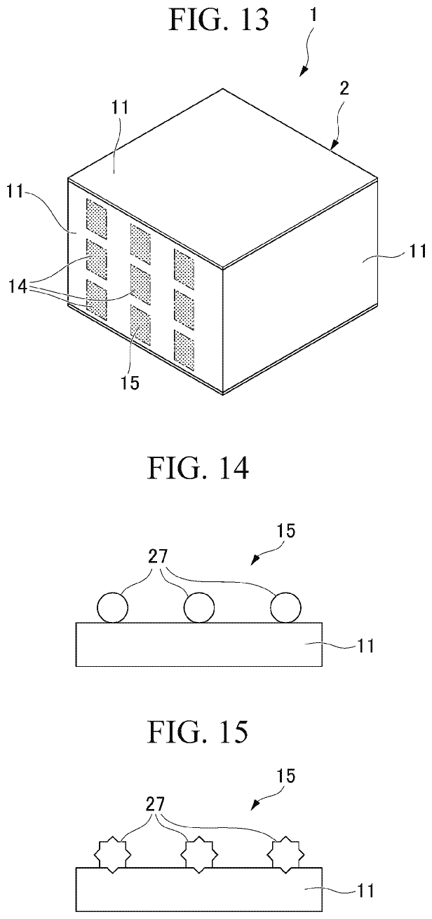

A sixth embodiment according to the present invention will be described. FIG. 13 is an external perspective view of a flying object 1 according to the sixth embodiment. FIG. 14 is a cross-sectional view of protrusions 15 according to the sixth embodiment. The embodiment is distinguished from the above-mentioned embodiment in that the protrusions 15 are provided on the panel 11.

As shown in FIG. 13, each of the panels 11 has a plurality of split regions 14 split in a rectangular shape. In the embodiment, the nine split regions 14, which are disposed at intervals, are disposed at equal intervals from the panels 11. The protrusions 15 are formed in the split regions 14.

As shown in FIG. 14, the protrusions 15 are provided on a surface of the panel 11 directed outward. The protrusions 15 protrude toward the outward side of the housing 2. Specifically, the protrusions 15 are a plurality of particle bodies 27 fixed to a surface of the panel 11. Each of the particle bodies 27 is formed in a spherical shape.

Further, the number and disposition of the split regions 14 are not limited to the above-mentioned embodiment. In addition, the protrusions 15 may be provided throughout the entire surface of the panel 11.

According to the configuration of the embodiment, since the panel 11 has the protrusions 15, points at which air stagnates is easily generated in the vicinity of the protrusions 15 on the outer surface of the housing 2. Since the air becomes a higher temperature in such stagnation points, the housing 2 can be heated to a higher temperature in comparison with the case in which the panel 11 does not have the protrusions 15.

Here, when the embodiment is applied to a large housing such as rocket pairing, a large scale satellite, a high pressure gas tank, or the like, there is a need to increase a plate thickness of the panel 11. When the low melting point member 3 is contained in the panel 11 having such a large thickness, the temperature of the panel 11 cannot be sufficiently increased upon atmospheric re-entry, and the low melting point member 3 may not be sufficiently heated. Accordingly, the housing 2 may not be reliably broken down.

According to the configuration of the embodiment, in comparison with the case in which the panel 11 does not have the protrusions 15, the panel 11 upon atmospheric re-entry can be heated to a higher temperature. Accordingly, the panel 11 that constitutes the housing 2 can be more reliably incinerated.

### (First Variant of Sixth Embodiment)

A first variant of the sixth embodiment according to the present invention will be described. FIG. 15 is a cross-sectional view of protrusions 15 according to the first variant of the sixth embodiment. The embodiment is distinguished from the above-mentioned embodiment in that each of the particle bodies 27 is formed in a polygonal shape.

In the embodiment, the particle bodies 27 that constitute the protrusions 15 are formed such that cross-sectional shapes thereof are polygonal shapes.

According to the configuration of the embodiment, in comparison with the case in which each of the particle bodies 27 is formed in a spherical shape, a nose radius of each of the particle bodies 27 can be reduced. Here, a heating rate of the panel 11 upon atmospheric re-entry is increased as a nose radius of each of the particle bodies 27 is reduced. Accordingly, since a cross-sectional shape of each of the particle bodies 27 is a polygonal shape, in comparison with the case in which each of the particle bodies 27 is formed in a spherical shape, a nose radius of the protrusion 15 can be reduced, and a heating rate of the panel 11 can be improved. Accordingly, even when the panel 11 having a large thickness is used, the housing 2 can be reliably broken down and incinerated.

Further, the technical spirit of the present invention is not limited to the above-mentioned embodiments, and various modifications may be made without departing from the scope of the present invention.

For example, the low melting point member 3 may be attached to the housing 2 from an inward side of the housing 2 or may be attached to the housing 2 from an outward side of the housing 2. In addition, the attachment position or the number of the low melting point members 3 is not limited to the above-mentioned embodiment.

The low melting point member 3 may be formed of, for example, iron, or may be formed of a resin member or the like including an organic fiber, a glass fiber, a bio fiber, or the like. However, the configuration of the embodiment using magnesium, aluminum, or the like, is superior in that processing is easily performed and fusion or sublimation is easily performed because a melting point is lower than that of iron.

The low melting point member 3 and the panels 11 may be mechanically coupled by rivets, bolts, or the like (not shown).

The protrusions may be provided on a part of the panel 11. The protrusions 15 may be formed on a surface of the low melting point member 3.

The housing 2 may be formed in a polyhedron shape such as a tetrahedron shape, an octahedron shape, a triangular prism shape, or the like, in addition to a rectangular parallelepiped shape.

In addition, the housing 2 may also be applied as a housing such as a high pressure gas tank or the like.

The flying object 1 in the above described embodiment, the flying object is preferably a flying object that flies at an altitude of 200 to 400 km from the surface of the earth.

This is because when the launch altitude from the surface of the earth becomes higher, the launching cost such as fuel increases more.

In addition, when the launch altitude of the flying object 1 is closer to the atmosphere below 200 km, the sooner the flying object 1 can start falling into the atmosphere after the mission of the flying object 1 has terminated, and therefore, it is possible to suppress the generation of a space debris.

Furthermore, in the flying object 1 of the above described embodiment, even in a case a sufficient speed cannot be obtained at atmospheric re-entry, it is possible to certainly break the housing and to improve the incineration characteristics at the time of atmospheric re-entry.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A flying object comprising:
a housing formed by combining a plurality of panels including reinforced fibers and a matrix resin; and
a low melting point member having a lower melting point than that of at least the reinforced fibers,
wherein the housing is configured to be breakable according to a change of the low melting point member during either of fusion or sublimation.

2. The flying object according to claim 1, wherein a cavity section is formed in at least a part of the housing, and
the low melting point member covers at least a part of the cavity section.

3. The flying object according to claim 2, wherein the housing is formed in a polyhedron shape, and
the cavity section is provided on at least one of a side of the housing that is a boundary portion between neighboring surfaces of the housing.

4. The flying object according to claim 2, wherein the housing is formed in a polyhedron shape, and
the cavity section is provided in at least one of a surface of the housing.

5. The flying object according to claim 2, wherein the housing is formed in a polyhedron shape, and
the cavity section is provided in at least one of a corner section of the housing.

6. The flying object according to claim 1, wherein the low melting point member has a fibrous form, and is provided integrally with the panel when the low melting point member is contained in the panel.

7. The flying object according to claim 1, wherein the low melting point member is provided integrally with the panel when the low melting point member is contained in the matrix resin.

8. The flying object according to claim 1, wherein the panel has a protrusion protruding outward from the housing.
